(19) United States
(12) Patent Application Publication
(10) Pub. No.: US 2011/0275007 A1
(43) Pub. Date: Nov. 10, 2011

(54) SOLID OXIDE FUEL CELL AND METHOD FOR MANUFACTURING THE SAME

(75) Inventors: Han Wool RYU, Seoul (KR); Bon Seok Koo, Seoul (KR); Jae Hyuk Jang, Seoul (KR); Hong Ryul Lee, Gyunggi-do (KR)

(73) Assignee: SAMSUNG ELECTRO-MECHANICS CO., LTD., Gyunggi-do (KR)

(21) Appl. No.: 13/092,074

(22) Filed: Apr. 21, 2011

(30) Foreign Application Priority Data
May 6, 2010 (KR) 10-2010-0042624

(51) Int. Cl. H01M 8/10; H01M 8/00

(52) U.S. Cl. 429/488; 427/115

(57) ABSTRACT

Disclosed herein are a solid oxide fuel cell and a method for manufacturing the same. The solid oxide fuel cell includes an anode layer; a cathode layer; an electrolyte layer interposed between the anode layer and the cathode layer; wherein the anode layer includes an Si-based compound selected from a group consisting of SiC, Si₃N₄, and a mixture thereof. The present invention performs a role of the chain at the boundary of the anode layer and the electrolyte layer by applying the Si-based compound to the anode layer to improve the wettability of metal particles and suppressing the grain growth, thereby making it possible to improve the long-term reliability of the fuel cell.

### CROSS REFERENCE TO RELATED APPLICATION

This application claims the benefit of Korean Patent Application No. 10-2010-0042624, filed on May 6, 2010, entitled “Solid Oxide Fuel Cell And Manufacturing Method Thereof”, which is hereby incorporated by reference in its entirety into this application.

### BACKGROUND OF THE INVENTION

1. Technical Field

The present invention relates to a solid oxide fuel cell and a method for manufacturing the same.

2. Description of the Related Art

A solid oxide fuel cell is operated at the highest temperature (700 to 1000° C.) among fuel cells using solid oxide having oxygen or hydrogen ion conductivity as an electrolyte and all components of the solid oxide fuel cell are made of solid, such that it has a simpler structure, does not lead to problems, such as the loss, supplement, corrosion of the electrolyte, does not require a noble metal catalyst, and facilitates the supply of fuel by direct internal reforming, as compared to other fuel cells. Further, the solid oxide fuel cell discharges high-temperature gas, such that it can perform a cogeneration plant using waste heat. Due to these advantages, research into the solid oxide fuel cell has been actively conducted in advanced countries such as the USA, Japan, or the like, for the purpose of commercialization at the beginning of 21 century.

A general solid oxide fuel cell is configured to include a dense electrolyte layer of oxygen ion conductivity and porous cathode and anode layers positioned at both sides thereof. The operational principle transmits oxygen in the porous cathode and reaches the electrolyte surface and moves oxygen ion generated by the reduction reaction of oxygen to the anode through the dense electrolyte and then, reacts with hydrogen supplied to the porous anode, thereby generating water. In this case, since electrons are generated in the anode and electrons are consumed in the cathode, electricity flows when two electrodes are connected to each other.

The anode of the fuel cell performs the electrochemical oxidation reaction of fuel, is stabilized in a reduction atmosphere, and has sufficient electron conductivity and catalyst reactivity for the reaction of fuel gas at an operational temperature.

However, if the operational time of the solid oxide fuel cell is long at the high operational temperature of 600° C. or more, a metal phase is agglomerated and the metal particle is grown in the metal-ceramic composite of the anode to reduce a triple phase boundary across which an electrode, an electrolyte, and gas come, thereby reducing the electrical conductivity and degrading the performance of the fuel cell.

A method for manufacturing a fuel cell according to the preferred embodiment of the prior art will be described below by way of example.

As the method for manufacturing a fuel cell according to the related art, a typical method for manufacturing an electrode for a porous fuel cell mixing by molding a metal-ceramic composite such as Ni—YSZ as a host material, a binder, additives, and a carbon black pore, heat-treating it, and burning out the pore at high temperature has been used. The method manufactures the anode electrode by controlling the size of metal Ni particles having electrical conductivity within the YSZ ceramic phase and the size of Ni particles on the YSZ phase according to the specific surface and shape thereof.

However, the anode for the fuel cell manufactured as described above gradually stops the pores by agglomerating and growing the metal Ni particles for long term operation to reduce the triple phase boundary, thereby degrading the performance of the fuel cell.

Therefore, there is a need for a unit controlling the agglomeration of the metal phase of the anode and suppressing it to prevent the performance the unit cell of the fuel cell from being degraded for long term operation and secure the long-term operation performance.

### SUMMARY OF THE INVENTION

The present invention has been made in an effort to provide a solid oxide fuel cell capable of suppressing a growth of metal particles of a metal-ceramic composite of an anode during the operation thereof at high temperature to prevent the performance of the fuel cell from being degraded for long term operation, and a method for manufacturing the same.

Further, the present invention has been made in an effort to provide a solid oxide fuel cell capable of improving mechanical characteristics by assisting the sintering of ceramic phase and a method for manufacturing the same.

In addition, the present has been made in effort to provide a solid oxide fuel cell capable of performing a role of a chain at a boundary of an anode and an electrolyte layer to improve wettability of metal particles, and a method for manufacturing the same.

According to a preferred embodiment of the present invention, there is provided a solid oxide fuel cell, including: an anode layer; a cathode layer; and an electrolyte layer interposed between the anode layer and the cathode layer; wherein the anode layer includes an Si-based compound selected from a group consisting of SiC, Si₃N₄, and a mixture thereof.

The content of the Si-based compound included in the anode layer may be 0.3 to 10 mol %.

The anode layer may include an anode support layer and an anode functional layer.

The anode support layer may include 0.3 to 10 mol %, more preferably, 0.1 to 3 mol % of Si-based compound selected from a group consisting of SiC, Si₃N₄, and a mixture thereof.

The anode layer may include a metal-ceramic composite selected from a group consisting of Ni—YSZ, Ni—ScSZ, Ni-GDC, Ni—CSZ, Cu-LSGM, Cu—YSZ, Cu—ScSZ, Cu-GDC, Cu—CSZ, Cu-LSGM and a mixture thereof.

According to another preferred embodiment of the present invention, there is provided a method for manufacturing a solid oxide fuel cell, including: forming an anode layer; forming an electrolyte layer on the anode layer; and forming a cathode layer on the electrolyte layer, wherein the anode layer include an Si-based compound selected from a group consisting of SiC, Si₃N₄, and a mixture thereof.

The forming the anode layer may include: forming an anode support layer; and forming an anode functional layer on the anode support layer.

The method for manufacturing a solid oxide fuel cell may further include sintering after the forming the anode layer, after the forming the electrolyte layer, and after the forming the cathode layer, respectively.

### BRIEF DESCRIPTION OF THE DRAWINGS

FIG. 1 is a diagram for schematically explaining a grain growth suppressing mechanism at a triple phase boundary of a fuel cell by a Si-based compound.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second” and so on are used to distinguish one element from another element, and the elements are not defined by the above terms.

Hereinafter, preferred embodiments of the present invention will be described in detail with reference to the accompanying drawings.

Solid Oxide Fuel Cell

A solid oxide fuel cell according to a preferred embodiment of the present invention may be configured to include an anode layer, a cathode layer, and an electrolyte layer interposed between the anode layer and the cathode layer.

The anode layer receives fuel to generate current and collects the generated current to supply electric energy to external circuits.

According to the present invention, the anode layer includes at least one Si-based compound selected from SiC and Si₃N₄. In this case, the content of the Si-based compound included in the anode layer is 0.3 to 10 mol %, preferably, 0.1 to 3 mol %, which is preferable to improve desired long-term reliability against efficiency.

The anode layer may also include the general metal-ceramic composite known to those skilled in the art.

An example of the metal-ceramic composite may include at leas one of Ni-yttria-stabilized zirconia (YSZ), Ni-scandium-stabilized zirconia (ScSZ), Ni-gadolinia-doped ceria (GDC), Ni—CSZ (Ceria-stabilized zirconia), Gu-lanthanum-strontium-gallium-magnesium (LSGM), Cu—YSZ, Cu—ScSZ, Cu-GDC, Cu—CSZ, and Cu-LSGM, but is not specifically limited thereto if being known to those skilled in the art.

According to the preferred embodiment of the present invention, the anode layer may be configured to include an anode support layer and an anode functional layer.

Preferably, the anode support layer may include a Si-based compound selected from a group consisting of SiC, Si₃N₄, and a mixture thereof. The content of the Si-based compound included in the anode layer is 0.3 to 10 mol %, preferably, 0.1 to 3 mol %, which is preferable to improve desired long-term reliability against efficiency.

The anode support layer typically has porous property transmitting gas while supporting the anode functional layer in order to supply fuel to the anode functional layer.

The anode support layer and the anode functional layer may be made of the same host material. The host material is described in the metal-ceramic composite of the anode layer.

The electrolyte layer is formed between the anode layer and the cathode layer. The electrolyte layer does not pass current and passes only protons to the cathode layer, when hydrogen is, for example, used as fuel. The electrolyte layer may be made of a ceramic material, such as yttria stabilized zirconia (YSZ) or scandium stabilized zirconia (ScSZ), GDC, LDC, or the like, but is not limited thereto.

The cathode layer combines protons supplied from the electrolyte layer, electrons supplied via external circuits, and oxygen in air to generate water. The cathode layer may be made of composition such as strontium doped lanthanum manganite (LSM), LSCF ((La, Sr) (Co, Fe) O₃), or the like, but is not specifically limited thereto.

As described above, according to the present invention, a small amount of SI-based compound having low surface energy is added within the metal-ceramic matrix of the anode under the high-temperature driving of the fuel cell, thereby making it possible to provide the fuel cell that minimizes the degradation in performance of the fuel cell for long term operation.

In more detail, the Si-based compound is added to the existing anode host material (metal-ceramic matrix) to suppress the grain growth of metal particles and improve the mechanical characteristics by assisting the sintering of ceramic phase and performs a role of a chain at a boundary of the anode and the electrolyte layer to improve the wettability of the metal particles.

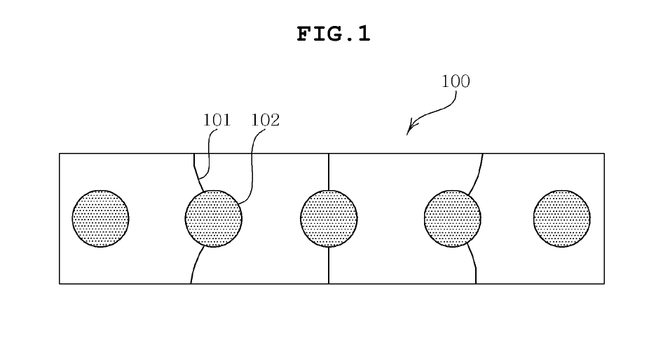

FIG. 1 is a diagram for schematically explaining a grain growth suppressing mechanism at a triple phase boundary of a fuel cell by a Si-based compound.

Referring to FIG. 1, a large amount of energy to grow grain by passing through Si compound 102 particles added to a path and moving a grain boundary 101 during the movement of the grain boundary 101 for grain growth in the metal-ceramic matrix 100 is required.

Therefore, the Si compound formed in the matrix of the fuel cell anode operated under the high-temperature reduction atmosphere suppresses the grain growth of the metal particles within the electrode for the fuel cell due to a pinning effect to prevent the porosity and triple phase boundary from being reduced, thereby making it possible to minimize the degradation in performance.

Method For Manufacturing Solid Oxide Fuel Cell

The method for manufacturing the solid oxide fuel cell according to the preferred embodiment of the present invention includes forming the anode layer, forming the electrolyte layer on the anode layer, and forming the cathode layer on the electrolyte layer.

The anode layer may be formed by molding and sintering a raw material mixing powder into a desired shape such as a cylindrical shape or a flat tubular shape by an extrusion molding method, or the like, but is not specifically limited thereto.

The raw material mixing powder may further include a binder, a pore, and other additives known to those skilled in the art, including functional components such as the Si-based compound, the precursor of the metal-ceramic composite to be described below.

The anode layer formed as described above includes at least one Si-based compound selected from SiC and Si₃N₄. In this case, the content of the Si-based compound included in the anode layer is 0.3 to 10 mol %, preferably, 0.1 to 3 mol %, which is preferable to improve desired long-term reliability against efficiency.

The anode layer may also include the general metal-ceramic composite known to those skilled in the art.

An example of the metal-ceramic composite may include at least one of Ni—YSZ, Ni—ScSZ, Ni-GDC, Ni—CSZ, Gu-LSGM, Cu—YSZ, Cu—ScSZ, Cu-GDC, Cu—CSZ, and Cu-LSGM, but is not specifically limited thereto if being known to those skilled in the art.

According to the preferred embodiment of the present invention, the forming of the anode layer may include forming the anode support layer and forming the anode functional layer on the anode support layer.

The anode support layer is formed in a desired form by extruding and molding a predetermined amount of raw material mixing powder including, for example, the Si-based compound. Then, the anode functional layer may be formed by coating, forming, and sintering a predetermined amount of raw material mixing powder by a slip coating method, a plasma spray coating method, or the like, but is not specifically limited thereto.

The anode support layer typically has porous property transmitting gas while supporting the anode functional layer in order to supply fuel to the anode functional layer.

According to the preferred embodiment of the present invention, the anode support layer may include a Si-based compound selected from a group consisting of SiC, Si₃N₄, and a mixture thereof. The content of the Si-based compound included in the anode layer is 0.3 to 10 mol %, preferably, 0.1 to 3 mol %, which is preferable to improve desired long-term reliability against efficiency.

The anode support layer and the anode functional layer may be made of the same host material. The host material is described in the metal-ceramic composite of the anode layer.

The electrolyte layer may be formed by coating and sintering, for example, the YSZ or the ScSZ, the GDC, the LDC, or the like, by using the slip coating method, the plasma spray coating method, or the like, but is not specifically limited thereto.

The cathode layer may be formed by coating and sintering, for example, the composition of the LSM, LSCF((La,Sr)(Co,Fe) O₃), or the like, by using the slip coating method, the plasma spray coating method, or the like, but is not specifically limited thereto.

Meanwhile, after the forming the anode layer, after the forming the electrolyte layer, and after the forming the cathode layer, respectively, sintering may further be provided. In some cases, the sintering process is performed after the forming the anode layer and the electrolyte layer and then, the cathode layer may be formed.

As described above, the present invention can suppress the agglomeration and growth of the metal particles when the metal-ceramic composite within the anode is sintered, by to adding a relatively small amount of Si compound when the anode is manufactured.

Further, the present invention performs the role of the chain at the boundary of the anode and the electrolyte while improving the mechanical characteristics by assisting the sintering of the ceramic phase, thereby making it possible to improve the wettability of the metal particles.

Further, the present invention prevents the agglomeration and growth of the metal particles in the anode for long term operation at the high temperature and prevents the reduction in the porosity and the triple phase boundary, thereby making it possible to minimize the degradation in performance of the fuel cell.

As set forth above, the present invention suppresses the agglomeration and growth of the metal particles by introducing the Si-based compound into the anode layer to stop the reduction in the porosity and the triple boundary to maintain the high electrical conductivity for long term operation, thereby making it possible to minimize the degradation in the performance of the fuel cell.

Further, the present invention can improve the mechanical characteristics of the fuel cell by assisting the sintering of the ceramic phase.

Further, the present invention performs a role of the chain at the boundary of the anode and the electrolyte layer to improve the wettability of metal particles, thereby making it possible to improve the long-term reliability of the fuel cell.

Although the preferred embodiments of the present invention have been disclosed for illustrative purposes, they are for specifically explaining the present invention and thus the solid oxide fuel cell and the method for manufacturing the same according to the present invention are not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A solid oxide fuel cell, comprising:
an anode layer;
a cathode layer; and
an electrolyte layer interposed between the anode layer and the cathode layer;
wherein the anode layer includes an Si-based compound selected from a group consisting of SiC, Si₃N₄, and a mixture thereof.

2. The solid oxide fuel cell as set forth in claim 1, wherein the content of the Si-based compound included in the anode layer is 0.3 to 10 mol %.

3. The solid oxide fuel cell as set forth in claim 1, wherein the anode layer includes an anode support layer and an anode functional layer.

4. The solid oxide fuel cell as set forth in claim 3, wherein the anode support layer includes 0.3 to 10 mol % of Si-based compound selected from a group consisting of SiC, Si₃N₄, and a mixture thereof.

5. The solid oxide fuel cell as set forth in claim 3, wherein the anode support layer includes 0.1 to 3 mol % of Si-based compound selected from a group consisting of SiC, Si₃N₄, and a mixture thereof.

6. The solid oxide fuel cell as set forth in claim 1, wherein the anode layer includes a metal-ceramic composite.

7. The solid oxide fuel cell as set forth in claim 6, wherein the metal-ceramic composite is selected from a group consisting of Ni-yttria-stabilized zirconia (YSZ), Ni-scandium-stabilized zirconia (ScSZ), Ni-gadolinia-doped ceria (GDC), Ni—CSZ (Ceria-stabilized zirconia), Gu-lanthanum-strontium-gallium-magnesium (LSGM), Cu—YSZ, Cu—ScSZ, Cu-GDC, Cu—CSZ, Cu-LSGM, and a mixture thereof.

8. A method for manufacturing a solid oxide fuel cell, comprising:
forming an anode layer;
forming an electrolyte layer on the anode layer; and
forming a cathode layer on the electrolyte layer,
wherein the anode layer include an Si-based compound selected from a group consisting of SiC, Si₃N₄, and a mixture thereof.

9. The method for manufacturing a solid oxide fuel cell as set forth in claim 8, wherein the content of Si-based compound included in the anode layer is 0.3 to 10 mol %.

10. The method for manufacturing a solid oxide fuel cell as set forth in claim 8, wherein the forming the anode layer includes:
forming an anode support layer; and
forming an anode functional layer on the anode support layer.

11. The method for manufacturing a solid oxide fuel cell as set forth in claim 10, wherein the anode support layer includes 0.3 to 10 mol % of Si-based compound selected from a group consisting of SiC, Si₃N₄, and a mixture thereof.

12. The method for manufacturing a solid oxide fuel cell as set forth in claim 10, wherein the anode support layer includes 0.1 to 3 mol % of Si-based compound selected from a group consisting of SiC, Si₃N₄, and a mixture thereof.

13. The method for manufacturing a solid oxide fuel cell as set forth in claim 8, further comprising sintering after the forming the anode layer, after the forming the electrolyte layer, and after the forming the cathode layer, respectively.

14. The method for manufacturing a solid oxide fuel cell as set forth in claim 8, wherein the anode layer includes a metal-ceramic composite.

15. The method for manufacturing a solid oxide fuel cell as set forth in claim 14, wherein the metal-ceramic composite is selected from a group consisting of Ni—YSZ, Ni—ScSZ, Ni-GDC, Ni—CSZ, Cu-LSGM, Cu—YSZ, Cu—ScSZ, Cu-GDC, Cu—CSZ, Cu-LSGM, and a mixture thereof.
